(19) United States
(12) Patent Application Publication
(10) Pub. No.: US 2006/0215384 A1
(43) Pub. Date: Sep. 28, 2006

(54) [ILLUMINATION STRUCTURE OF A METER]

(75) Inventor: Hsu-Ming Liu, TAIPEI (TW)

Correspondence Address: TRISCO TECHNOLOGY CORP., P.O. BOX 108-00403, TAIPEI, TW

(73) Assignee: TRISCO TECHNOLOGY CORP., Taipei City (TW)

(21) Appl. No.: 10/907,282

(22) Filed: Mar. 28, 2005

(51) Int. Cl. G01D 11/28

(52) U.S. Cl. 362/23

(57) ABSTRACT

An illumination structure installed in a meter is disclosed to include a plurality of light emitting elements, for example, LEDs provided at a circuit board right below the center of a faceplate of the meter for emitting light toward the pointer of the meter, a light diffusion portion formed of a part of the faceplate of the meter through a sandblasting process for diffusing light in all directions in the space above the faceplate, and a light guide board mounted inside the meter between the circuit board and the faceplate around the LEDs for guiding the light from the LEDs toward the light diffusion portion to illuminate the faceplate.

### BACKGROUND OF THE INVENTION

1. Field of the Invention

The present invention relates to a meter and more specifically, to an illumination structure of a meter.

2. Description of the Related Art

A variety of meters and gauges are known for measuring the amount or speed of a fluid or gas, or for indicating direction or time. For example, a motor vehicle generally has a fuel indicator/gas gauge to indicate the amount of fuel oil, an oil pressure gauge to indicate the pressure of fuel oil, an engine temperature gauge to indicate engine temperature, a tachometer to measure engine speed, and an odometer to measure the distance traveled by the vehicle. In additional to vehicle internal meters/gauges, a car driver may attach a meter to the inside of the car for car performance setup indication. For example, a car driver may install an attached meter for setting up a speed limit. When the speed of the car surpassed the setup value, the attached meter immediately gives a warning signal to the car driver.

When in the daytime or under the environment where illumination is sufficient, the driver can see the indication of the meter clearly. However, when in the night or under a dark environment, a light source is needed to illuminate the meter so that the driver can see the indication of the meter. FIG. 6 is a sectional side view of a conventional meter. As illustrated, the meter has LEDs B mounted in the accommodating chamber A1 inside the casing A thereof. The LEDs B are controlled to emit light toward the faceplate A2, enabling the user to see the indication of the pointer C of the meter. This meter illumination design is not satisfactory in function because of the following drawbacks.

1. Because the light from the LEDs is not concentrated on a particular location at the faceplate, the weak illumination of the LEDs is insufficient to allow the user to see the indication of the pointer clearly.

2. Because the light from the LEDs passes to the bottom side of the faceplate, the pointer is not well illuminated to show the indication.

### SUMMARY OF THE INVENTION

The present invention has been accomplished under the circumstances in view. It is therefore the main object of the present invention to provide an illumination structure for meter, which illuminates the pointer as well as the faceplate, enabling the user to see the indication pointed by the pointer at the graduations of the faceplate clearly in the dark. To achieve this and other objects of the present invention, the illumination structure is installed in a meter, which comprises a casing covered with a glass cover, a faceplate marked with graduations and mounted inside the casing, at least one circuit board mounted inside the casing, a mini motor, which is mounted in the circuit board and has an output shaft vertically upwardly extending through a center through hole of the faceplate, and a pointer fixedly fastened to the output shaft of the mini motor above the faceplate and movable with the output shaft of the mini motor relative to the faceplate to point out the graduations at the faceplate. The illumination structure comprises a plurality of light emitting elements installed in the circuit board and controlled by the circuit board to emit light toward the pointer, light diffusion means formed integral with a part of the faceplate and adapted to diffuse light in all directions in the space above the faceplate within the casing, and light guide means mounted inside the casing between the circuit board and the faceplate around the light emitting elements and adapted to guide the light from the light emitting elements toward the light diffusion means.

### BRIEF DESCRIPTION OF THE DRAWINGS

FIG. 1 is an elevational view of an illumination structure according to the present invention.

FIG. 2 is an exploded view of the illumination structure according to the present invention.

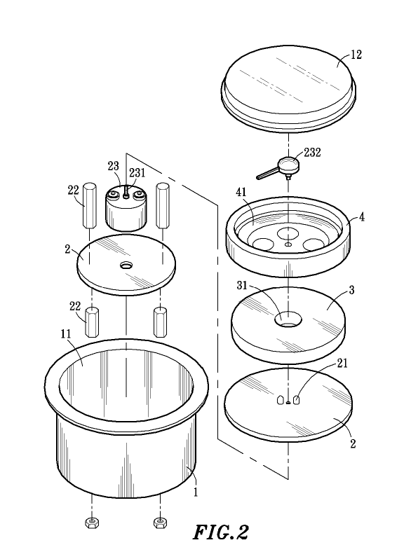

FIG. 3 is a sectional side view of the illumination structure according to the present invention.

FIG. 4 is a schematic drawing showing the illumination structure in action according to the present invention.

FIG. 5 is a sectional side view of an alternate form of the present invention.

FIG. 6 is a sectional side view of a conventional meter.

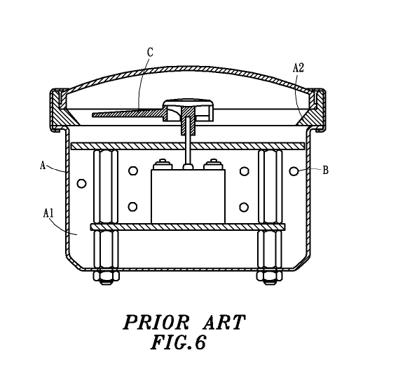

### DETAILED DESCRIPTION OF THE PREFERRED EMBODIMENT

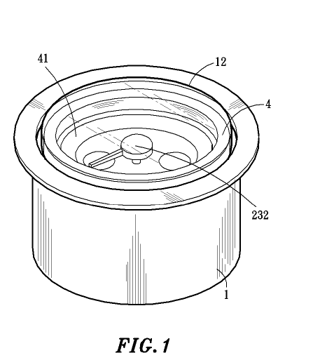

Referring to FIGS. 1˜3, an illumination structure in accordance with the present invention is shown comprising a casing 1, a circuit board unit, a light guide board 3, and a faceplate 4.

The casing 1 is a hollow member defining an accommodating chamber 11 and covered with a glass cover 12.

The aforesaid circuit board unit according to the present preferred embodiment comprises two circuit boards 2, a plurality of support rods 22 that support the two circuit boards 2 inside the casing 1 at different elevations, a mini motor 23 vertically mounted on the bottom one of the two circuit boards 2 at the center and having an output shaft 231 vertically upwardly inserted through (the center through hole of) the top one of the two circuit boards 2 and fixedly fastened with a pointer 232 that admits light, and a plurality of light emitting elements, for example, LEDs (light emitting diodes) 21 installed in the top one of the circuit boards 2 and controllable to give off light.

The light guide board 3 is a flat member made from transmittive material, having a center opening 31 extending through the top and bottom sides thereof.

The faceplate 4 is a hollow member made from transmittive material and marked with graduations, having a light diffusion portion 41 disposed at the border area adapted to diffuse light. Sandblasting the border area of the faceplate 4 makes the light diffusion portion 41.

During installation, the aforesaid circuit board unit is mounted inside the accommodating chamber 11 of the casing 1, and then the light guide board 3 is mounted on the top one of the circuit boards 2, keeping the LEDs 21 suspending in the center opening 31 of the light guide board 3, and then the faceplate 4 is mounted on the light guide board 3, keeping the output shaft 231 of the mini motor 23 inserted through the top one of the circuit boards 2, the center opening 31 of the light guide board 3 and the faceplate 4, and then the pointer 232 is fixedly fastened to the free end of the output shaft 231 of the mini motor 23 and suspending right above the LEDs 21, and then the glass cover 12 is capped on the casing 1.

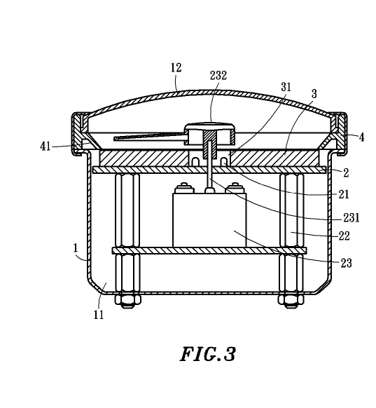

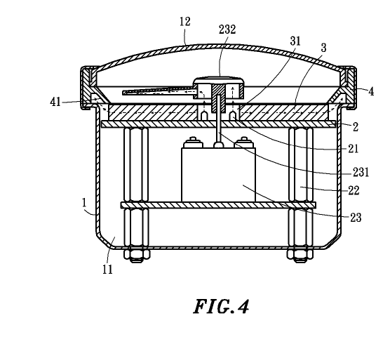

Referring to FIG. 4 and FIG. 3 again, when electrically connected, the LEDs 21 are turned on to give off light. The light from the LEDs 21 has a part passing to the transmittive pointer 232 and a part passing through the light guide board 3 to the light diffusion portion 41, which diffuses the light in all directions in the space above the faceplate 4 to illuminate the graduations at the faceplate 4. Therefore, the user can see the indication of the pointer 232 clearly in the night.

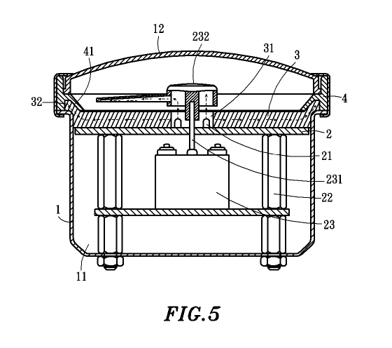

Referring to FIG. 5, the light guide board 3 has a peripheral flange 32 curved outwardly upwards and closely attached to the bottom side of the light diffusion portion 41 of the faceplate 4 for guiding the light from the LEDs 21 to the light diffusion portion 41 of the faceplate 4.

As indicated above, the illumination structure of the present invention has the features as follows.

1. Light emitting elements are provided at the circuit board right below the pointer of the meter so that the light from the light emitting elements efficiently illuminates the pointer of the meter.

2. A light guide board is arranged around the light emitting elements to guide the light from the light emitting elements to the border area of the faceplate of the meter, enabling the user to see the indication of the pointer clearly.

A prototype of illumination structure of a meter has been constructed with the features of FIGS. 1˜5. The illumination structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An illumination structure installed in a meter comprising a casing covered with a glass cover, a faceplate marked with graduations and mounted inside said casing, at least one circuit board mounted inside said casing, a mini motor mounted in said circuit board, said mini motor having an output shaft vertically upwardly extending through a center through hole of said faceplate, and a pointer fixedly fastened to the output shaft of said mini motor above said faceplate and movable with the output shaft of said mini motor relative to said faceplate to point out the graduations at said faceplate, the illumination structure comprising a plurality of light emitting elements installed in said circuit board and controlled by said circuit board to emit light toward said pointer, light diffusion means formed integral with a part of said faceplate and adapted to diffuse light in all directions in the space above said faceplate within said casing, and light guide means mounted inside said casing between said circuit board and said faceplate around said light emitting elements and adapted to guide the light from said light emitting elements toward said light diffusion means.

2. The illumination structure as claimed in claim 1, wherein said pointer admits light.

3. The illumination structure as claimed in claim 1, wherein said faceplate has a border area treated with a sandblasting process to form said light diffusion means.

4. The illumination structure as claimed in claim 1, wherein said light guide means is a transmittive board member mounted on said circuit board, having a center opening cut through top and bottom sides thereof for accommodating said light emitting elements.

5. The illumination structure as claimed in claim 1, wherein said light emitting elements are light emitting diodes.
